(19) United States
(12) Patent Application Publication
(10) Pub. No.: US 2013/0148152 A1
(43) Pub. Date: Jun. 13, 2013

(54) METHODS AND SYSTEMS FOR HANDLING FAX RECEPTION WITH A HIGH DEGREE OF SECURITY

(71) Applicant: Poon Tai Cheung, Wanchai (HK)

(72) Inventor: Poon Tai Cheung, Wanchai (HK)

(21) Appl. No.: 13/323,646

(22) Filed: Dec. 12, 2011

(51) Int. Cl. G06K 15/02

(52) U.S. Cl. 358/1.14

(57) ABSTRACT

Methods and systems for handling fax reception with a high degree of security are provided. The system's components include a fax machine, an optical character recognition (“OCR”) component, a database, a radio-frequency (“RF”) reader configured to detect associated RF transmitters, a processor, and memory. The OCR component, database, RF reader, processor and memory are all in or around the fax machine. The RF transmitters are each associated with a fax recipient. The database stores information regarding fax recipients. The memory comprises instructions that cause the processor to execute a method. The method involves selectively printing incoming faxes based on one or more of a number of factors. The factors include the recipient of the fax, the location of the recipient with respect to the fax machine, and the degree of confidentiality of the fax. Recipients may also be notified of incoming faxes as well.

### FIELD OF THE INVENTION

This invention is generally related to fax machines. More specifically, this invention is related to fax machines that incorporate security clearance measures for accessing incoming faxes.

### BACKGROUND OF THE INVENTION

Fax machines have been a very popular means of communication for the past 20 years. Even with the advent of modern day computers and with network connectivity, fax machines remain an integral tool for sending and receiving documents with ease.

To some extent, fax machines are very useful because they allow physical documents sent from one to another using a phone line. Advantageously, fax machines offer point to point communications between two parties. By using a phone line, a sender can initiate the sending. The receiver, meanwhile, is not required to wait for the sender to fax the documents. As long as the phone line is connected, the sender can send transmit documents.

Because of these benefits, fax machines are still used almost everywhere. For example, fax machines can be found at home. In a household, a fax machine can typically be used by many people. Different family members may use the fax machine for different purposes. The primary use of fax machines is in offices. It is rather uncommon to find one person to occupy one fax machine at the desk. If one person has one fax machine at the desk, such use would become too uneconomical, requiring more fax machines and more phone lines. As one installation of fax machine requires one additional phone line of installation. Therefore, it is rather common to find multiple people sharing a fax machine in an office setting. A problem that may exist is that the sending party may not know whether a fax machine at the office is shared. When the incoming fax arrives, most fax machines would simply print out a copy of the fax. If the fax contains confidential information, such as potentially privileged legal documents, the fax would be exposed to all members sharing the fax machine. This may be undesirable to the workspace, especially if certain employees do not have proper security clearance to view such sensitive documents. Therefore, it is desirable to come up with solutions to resolve the above problems.

In view of the foregoing, there is a need for novel methods and systems of facilitating a security-enabled means of receiving faxes wherein it is ensure that certain faxes are only seen by those who are the recipients thereof.

### SUMMARY OF THE INVENTION

According to embodiments of the invention, a fax system for handling fax reception with a high degree of security is provided. The system's components include a fax machine, an optical character recognition (“OCR”) component, a database, a radio-frequency (“RF”) reader configured to detect associated RF transmitters, a processor, and memory. The OCR component, database, RF reader, processor and memory are all in or around the fax machine. The RF transmitters are each associated with a fax recipient. The database stores information regarding fax recipients. The memory comprises instructions that cause the processor to execute a method.

The method comprises the following the following steps. The method begins when a fax is incoming. Upon reception of the fax, it is determine if the fax contains the name of a recipient using the OCR component. If no recipient is recognized, the fax is rejected and the method over. If the fax contains the name of one or more of the recipients in the database, it is determined if the named recipient is within a certain radius of the fax system. This step is carried out by the RF reader detecting the RF transmitter associated with the particular recipient. If the person's RF transmitter is detected, then the fax is printed. If recipient is not in the vicinity, the fax machine refrains from printing the fax until the recipient is detected nearby.

In a further embodiment of the disclosed technology, the database comprises key words that, when detected in an incoming fax, cause that fax to be considered confidential. In this embodiment, if the fax does not contain any of the confidential keywords, the fax machine may print the fax as long as the recipient is in the database, regardless of whether the recipient is in the vicinity. If the fax does contain one or more of the confidentiality key words, then the fax is only printed when the recipient is detected to be in the vicinity of the fax machine as determined by the RF reader. This embodiment may further comprise steps of sending a notification to the fax recipient to alert them that a confidential fax awaits them at the fax machine. And then printing the fax when it is detected that the recipient is within a certain radius of the fax machine. In still a further embodiment, the confidentiality trigger key words may be personalized with respect to each of the fax recipients. The key words may also be defined by the fax recipients.

In another embodiment of the disclosed invention, fax system for handling fax reception with a high degree of security is provided. A fax machine is provided with an OCR component, a RF reader, a processor and a memory storage device. Furthermore, a plurality of RF transmitters is provided, each transmitter being associated with a potential fax recipient. The memory storage device stores a database which contains the names of one or more potential fax recipients. The fax machine is configured to print an incoming fax only when certain security measures are met.

In one embodiment, the security measures required to be met are the scanning of an incoming fax using the OCR component, and detecting of text identifying one or more of the potential fax recipients stored in the database. In further embodiment, the security measures also require that the fax recipient is within a certain radius of the fax machine, as detected by the RF reader and transmitter. In still a further embodiment, the security measures also require that the no confidential information is detected in the incoming fax (via the OCR component), and that the fax recipient is within a certain radius of the fax machine. As with previous embodiments, the fax machine may be configured to send a notification to the fax recipient in order to alert them that a fax awaits them at the fax machine.

It is, therefore, an objective of the disclosed invention to provide a system and method for enhancing the security and accessibility of fax reception in applications with multiple users.

In accordance with these and other objects which will become apparent hereinafter, the invention will now be described with particular reference to the drawing.

### BRIEF DESCRIPTION OF THE DRAWINGS

FIG. 1 shows an exemplary overview of a fax reception system with a high degree of security.

### DETAILED DESCRIPTION

Referring now to the figure, an exemplary overview of a fax reception system with a high degree of security according to embodiments of the present invention is shown. A fax machine 100 is shown provided. In embodiments of the present invention, the fax machine contains an optical character recognition (herein “OCR”) component, a database, a radio-frequency (herein “RF”) reader or receiver, a processor, and memory. The radio-frequency reader is configured to detect one or more of a plurality of RF transmitters via radio waves 110. Fax recipients 210, 220, 230 are provided with a RF transmitter as each transmitter is associated with a unique corresponding individual who will always have the transmitter on their person. As will be explained in greater detail below, the RF system will operate to ensure a high degree of security with respect to incoming faxes

Radio frequency identification (“RFID”) tagging is a known method of identification. An information carrying tag or transmitter functions in response to a coded radio frequency (“RF”) signal transmitted from a base station or reader. The RF carrier signal reflects from the transmitter and can be demodulated to recover information stored in the transmitter. The transmitter typically includes a semiconductor chip having RF circuits, logic, and memory, as well as an antenna. Various transmitter structures, circuits, and programming protocols are known in the art.

RFID systems typically have three components: (1) a tag (the item being identified), (2) an interrogator or reader, and (3) a data managing medium (typically including cabling, computers, and software which tie together the tags and interrogators into a useful solution). RF readers are typically designed to detect transmitter s when they pass within a predefined range of the reader.

There are generally two types of RF transmitters known in the art: passive RF transmitters and active RF transmitters. Passive RF transmitters, unlike active ones, do not require a battery in order to transmit a RF signal frequency. Instead, passive RF transmitters rely on an external source to provoke signal transmission. The reader transmits the operating power for these transmitters. As a result, such passive RFID systems generally have a detection range of limited to a couple meters. However, passive RF transmitters may generally be manufactured to be smaller in size than active RF transmitters due to the absence of a battery.

Most passive RFID systems work as follows. A reader emits an electromagnetic field for the purpose of powering the transmitters. A coil in the transmitters is powered by the electromagnetic field, causing the transmitter's circuitry to “wake up.” The transmitter uses this power to send an identifying signal back to the interrogator. It is envisioned that in the preferred embodiment of this invention, an active RF transmitter will be employed due to its ability to be detected over longer distances.

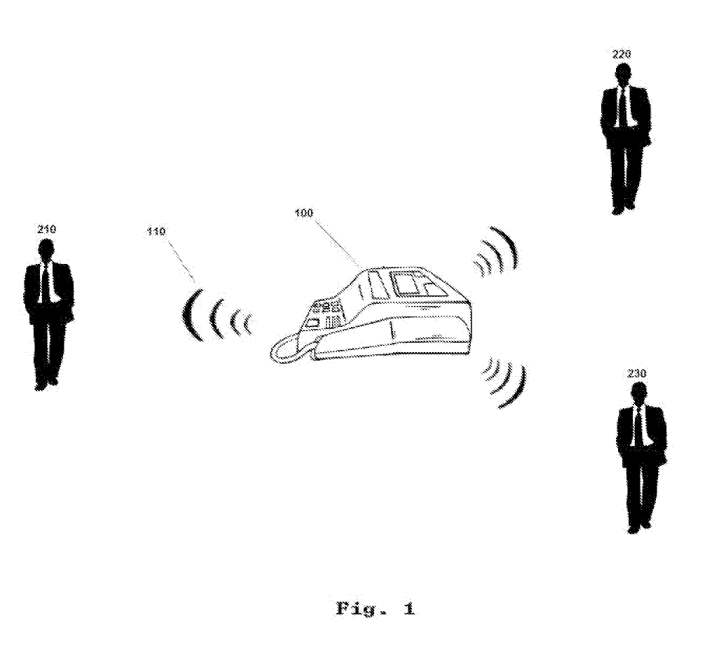

Referring still to FIG. 1, the OCR component, database, RF reader, processor and memory are all in or around the fax machine. The database stores information regarding fax recipients. The database may also store specific key words, such as those which may indicate that an incoming fax is confidential if they are present therein. OCR is widely known, and is often used to convert books and documents into electronic files. The OCR component does not require any specific hardware apart from a standard device for scanning documents. The OCR component works based on programming code stored in the memory, and executed by the processor.

The memory also comprises instructions that cause the processor to execute a method. The method comprises the following the following steps. The method begins when a fax is incoming. Upon reception of the fax, it is determine if the fax contains the name of a recipient using the OCR component. If no recipient is recognized, the fax is rejected and the method over. If the fax contains the name of one or more of the recipients in the database, it is determined if the named recipient is within a certain radius of the fax system. This determination is carried out by the RF reader detecting the RF transmitter associated with the particular recipient. If the person's RF transmitter is detected, then the fax is printed. If recipient is not in the vicinity, the fax machine refrains from printing the fax until the recipient is detected nearby. The detection radius may be anywhere from 10 feet to 300 feet, and is only limited by the range of the RFID system. It may be configured to certain radii based on the size of the particular office or home in which the invention will be used.

In a further embodiment of the disclosed technology, the database comprises key words that, when detected in an incoming fax, cause that fax to be considered confidential. In this embodiment, if the fax does not contain any of the confidential keywords, the fax machine may print the fax as long as the recipient is in the database, regardless of whether the recipient is in the vicinity. If the fax does contain one or more of the confidentiality key words, then the fax is only printed when the recipient is detected to be in the vicinity of the fax machine as determined by the RF reader. This embodiment may further comprise steps of sending a notification to the fax recipient to alert them that a confidential fax awaits them at the fax machine. And then printing the fax when it is detected that the recipient is within a certain radius of the fax machine. In still a further embodiment, the confidentiality trigger key words may be personalized with respect to each of the fax recipients. The key words may also be defined by the fax recipients.

In another embodiment of the disclosed invention, fax system for handling fax reception with a high degree of security is provided. A fax machine is provided with an OCR component, a RF reader, a processor and a memory storage device. Furthermore, a plurality of RF transmitters is provided, each transmitter being associated with a potential fax recipient. The memory storage device stores a database which contains the names of one or more potential fax recipients. The fax machine is configured to print an incoming fax only when certain security measures are met.

In one embodiment, the security measures required to be met are the scanning of an incoming fax using the OCR component and detecting text identifying one or more of the potential fax recipients stored in the database. In further embodiment, the security measures also require that the fax recipient is within a certain radius of the fax machine, as detected by the RF reader and transmitter. In still a further embodiment, the security measures also require that the no confidential information is detected in the incoming fax (via the OCR component, and that the fax recipient is within a certain radius of the fax machine. As with previous embodiments, the fax machine may be configured to send a notification to the fax recipient in order to alert them that a fax awaits them at the fax machine.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

What is claimed is:

1. A fax system for handling fax reception with a high degree of security, comprising:
a fax machine for receiving faxes;
an Optical Character Recognition (OCR) component within the fax machine;
a database included in the fax machine for storing information regarding fax recipients;
a radio-frequency (RF) reader in the fax machine configured to detect RF transmitters, each RF transmitter being associated with one or more of a plurality of fax recipients;
a processor; and
memory storing instructions that causes the processor to execute a method, the method comprising the following steps:
upon receiving an incoming fax, determining if the fax contains a name of any recipient using the OCR component; declining to print out the fax if no recipient is recognized;
determining if the recipient is one or more of the recipients in the database using the OCR component;
declining to print out the fax if recipient is not found in the database;
if the name belongs to a known person within the database, determining if the person is within a certain radius of the fax machine, based on detection by the RF reader and an RF transmitter carried by the fax recipient;
if the person is within the certain radius, printing out the fax; and
if the person fails to be within the certain distance,
temporarily declining to print out the fax until the person is within the certain radius, based on detection by the RF reader and the RF transmitter carried by the fax recipient.

2. A fax system for handling fax reception with a high degree of security, comprising:
a fax machine for receiving faxes;
an Optical Character Recognition (OCR) component within the fax machine;
a database included in the fax machine for storing information regarding fax recipients;
a radio-frequency (RF) reader in the fax machine configured to detect RF transmitters, each RF transmitter being associated with one or more of a plurality of fax recipients;
a processor; and
memory storing instructions that causes the processor to execute a method, the method comprising the following steps:
upon receiving an incoming fax, determining if the fax contains a name of any recipient using the OCR component;
declining to print out the fax if no recipient is recognized;
determining if the fax contains a name of one or more of the recipients in the database using the OCR component;
declining to print out the fax if recipient is not found in the database;
upon determining that a recipient's name is within the database, determining if the contents of the fax contains confidential information using a configured key word search of the text recognized by the OCR component;
printing out the fax provided that the fax does not contain confidential information;
if the name belongs to a known person within the database and the fax contains confidential information,
determining if the person is within a certain radius of the fax system, based on detection by the RF reader and the RF transmitter carried by the fax recipient;
if the person is within the certain radius, printing out the fax; and
if the person fails to be within the certain distance,
temporarily declining to print out the fax until the person is within the certain radius, based on detection by the RF reader and the RF transmitter carried by the fax recipient.

3. The fax system of claim 2, further comprising the following step:
sending a notification to the fax recipient alerting them that a confidential fax awaits them at the fax machine; and
printing out the fax when the person comes within a certain radius of the fax machine, based on detection by the RF reader and the RF transmitter carried by the recipient.

4. The fax system of claim 3, wherein the key words used to determine confidentiality by the OCR component are personalized with respect to each of the fax recipients and are defined by each of the fax recipients.

5. A fax system for handling fax reception with a high degree of security, comprising:
a fax machine comprising an Optical Character Recognition (OCR) component, a radio frequency (RF) reader, a processor, and a memory storage device;
a plurality of RF transmitters, each transmitter associated with a potential fax recipient;
said memory storage device storing a database which comprises data regarding names of one or more potential fax recipients; and
said fax machine configured to print incoming fax only when certain security measures are met, wherein said security measures comprise:
i. scanning said incoming fax using said OCR component and detecting text identifying one or more of said potential fax recipients stored in said database.

6. The fax system of claim 5, wherein said security measures further comprise:
determining with said RF reader that said fax recipient is within a certain radius of said fax machine.

7. The fax system of claim 5, wherein said security measures further comprise:
scanning said incoming fax using said OCR component and ensuring said incoming fax contains no text identifying any confidential key words, said keywords being stored in said database.

8. The fax system of claim 5, wherein said security measures further comprise:
i. scanning said incoming fax using said OCR component and detecting confidential information using a configured key word search of the text recognized by the OCR component; and
ii. determining with said RF reader that said fax recipient is within a certain radius of said fax machine.

9. The fax system of claim 5, wherein said fax machine is configured to send a notification to the fax recipient alerting them that a confidential fax awaits them at the fax machine.
